(19) United States
(12) Patent Application Publication
(10) Pub. No.: US 2009/0292426 A1
(43) Pub. Date: Nov. 26, 2009

(54) SYSTEM AND METHOD FOR CONTROLLING A PLANTER

(76) Inventors: Frederick William Nelson, Waukee, IA (US); Larry Lee Hendrickson, Johnston, IA (US)

Correspondence Address: DEERE & COMPANY, ONE JOHN DEERE PLACE, MOLINE, IL, 61265, US

(21) Appl. No.: 12/126,164

(22) Filed: May 23, 2008

(51) Int. Cl. G06F 19/00

(52) U.S. Cl. 701/50

(57) ABSTRACT

A system and method for controlling a planter comprises a boundary definer for establishing a boundary associated with a field. A location-determining receiver determines a position of a planter. A detector is capable of generating an activation signal if the location-determining receiver crosses the established boundary. An actuator is arranged for interrupting the dispensing of seed for a single planter row for a specified time duration or over a specified range of positions in response to the activation signal.

### FIELD OF THE INVENTION

This invention relates to a method and system for controlling a planter (e.g., to establish a visual marker).

### BACKGROUND OF THE INVENTION

A planter may be used to plant seeds, seedlings, plants, root stock, bulbs, or other crop precursors in rows in a field. The planter may be augmented with a location-determining receiver (e.g., Global Positioning System receiver) to facilitate straight linear, contour or parallel rows of planted seeds or other crop precursors. For example, the location-determining receiver provides guidance data to an operator or a steering system of the vehicle to keep the vehicle in aligned rows with minimal overlap to reduce fuel consumption. Accordingly, the planter may provide highly uniform, parallel rows, which make it difficult for other vehicle operators to visually identify where to spray, harvest or perform other field operations. Thus, there is the need to establish a method and system for controlling a planter to establish one or more visual markers for operators to perform operational tasks.

### SUMMARY OF THE INVENTION

A system and method for controlling a planter comprises a boundary definer for establishing a boundary associated with a field. A location-determining receiver determines a position of a planter. A detector is capable of generating an activation signal if the location-determining receiver crosses the established boundary. An actuator is arranged for interrupting the dispensing of seed or another crop precursor for at least one planter row for a specified time duration or over a specified range of positions in response to the activation signal.

### BRIEF DESCRIPTION OF THE DRAWINGS

FIG. 1 is a block diagram of one embodiment of a system for controlling a planter.

FIG. 2 is a block diagram of another embodiment of a system for controlling a planter.

FIG. 3 is a flow chart of a method for controlling a planter.

FIG. 4 is an aerial view looking down at an illustrative field planted in accordance with the method of FIG. 3.

### DESCRIPTION OF THE PREFERRED EMBODIMENT

As used herein, planter shall mean a planter or any planting implement for planting associated with a tractor or another agricultural vehicle. Planting means depositing any seed, plant, seedling, planting stock, root stock, bulbs, root tubers, or other crop precursors in or on any ground, soil, earth, sand, clay, organic matter, or other growing medium for growing vegetation.

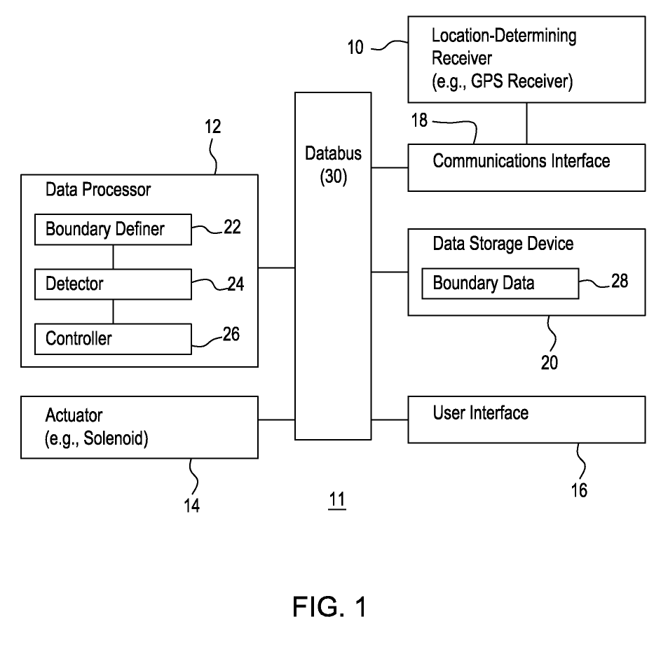

In accordance with one embodiment of the invention, FIG. 1 comprises a data processor 12 coupled to a data bus 30. The data processor 12 may communicate with one or more of the following components via the data bus 30: an actuator 14, a user interface 16, a data storage device 20, a communications interface 18, and the location-determining receiver 10. The communications interface 18 is coupled to a location-determining receiver 10.

The location-determining receiver 10 provides position data (e.g., coordinates or location data) related to the position of the planter, planting implement or vehicle associated with the planter or the planting implement. In one embodiment, the location-determining receiver 10 may comprise a Global Positioning System (GPS) receiver with a differential correction receiver to provide location data or coordinates with a desired degree of accuracy. The differential correction receiver may receive a terrestrial correction signal from a base station, a satellite correction signal from one or more satellites, or both.

The communications interface 18 provides an interface for communications between the location-determining receiver 10 and the data processor 12. For example, the communications interface 18 supports the communications or transmission of position data from the location-determining receiver 10 to the data processor 12 via the data bus 30. The communications interface 18 may comprise a communications port or data transceiver with a memory buffer. The memory buffer may support temporary storage of position data or other transmitted or received data.

The data processor 12 may comprise a microprocessor, a microcontroller, logic circuit, a programmable logic array, an application specific integrated circuit (ASIC), or another data processor. In one embodiment, the data processor 12 may support one or more of the following modules or software modules: a boundary definer 22, a detector 24, and a controller 26.

The boundary definer 22 may store boundary data 28 (e.g., boundary coordinates) associated with one or more boundaries or borders of a work area or field. For example, the boundary data 28 may be spaced apart from an external field edge, a headland, an internal obstacle or an internal zone within the field. The boundary data 28 may be stored as coordinates, points, equations (e.g., linear quadratic, or otherwise), linear segments, curves, or contours.

The detector 24 detects whether or not the planter has traversed or crossed the boundary indicated by the defined boundary data 28. If the detector 24 detects that the boundary or border has been traversed or crossed, the controller 26 generates or sends an activation signal to the actuator 14. The activation signal may comprise one or more of the following: a control signal, control data, a digital signal, an analog signal, a command message, and a status message.

The actuator 14 may comprise a solenoid, a pneumatic actuator, an electromechanical device, an electro-pneumatic assembly or another electromechanical device for controlling the flow, movement, or planting of seed, seedlings, plants, planting stock, root stock, bulbs, root tubers, or other crop precursors.

The data storage device 20 comprises electronic memory, random access memory, nonvolatile computer memory, optical memory, magnetic memory, a hard disk drive, or another suitable device for storing digital information or other data (e.g., boundary data 28).

The user interface 16 may comprise a keyboard, a keypad, a display, a pointing device (e.g., a mouse or trackball), a light bar, a panel of lights or light emitting diodes (LED's), or a switch for displaying output data or supporting the input or entry of input data into the system. The user interface 16 may accept input about the field, boundary data 28, boundary definitions, or the like, for example.

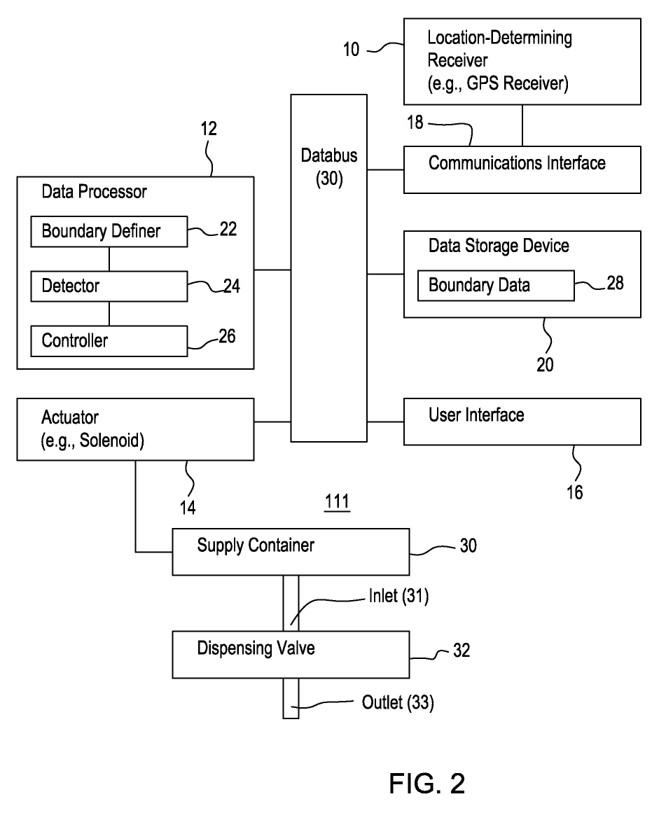

The system 111 of FIG. 2 is similar to the system 11 of FIG. 1, except the system 111 of FIG. 2 further comprises a supply container 30 and dispensing valve 32. The supply container 30 holds or contains a supply of seeds, root stock or other crop precursor for planting. The actuator 14 is coupled (e.g., mechanically coupled) to the dispensing valve 32 for opening, closing or adjustment of the dispensing valve 32. An inlet 31 of the dispensing valve 32 is in communication with the supply container 30 to receive seed or crop precursor from the supply container, whereas an outlet 33 of the dispensing valve 32 may be arranged to plant or disperse the seed or crop precursor. For example, the outlet 33 may be coupled to a planting device that is aligned to distribute the seed or crop precursor within a depression, row, or crevice formed in the soil or ground.

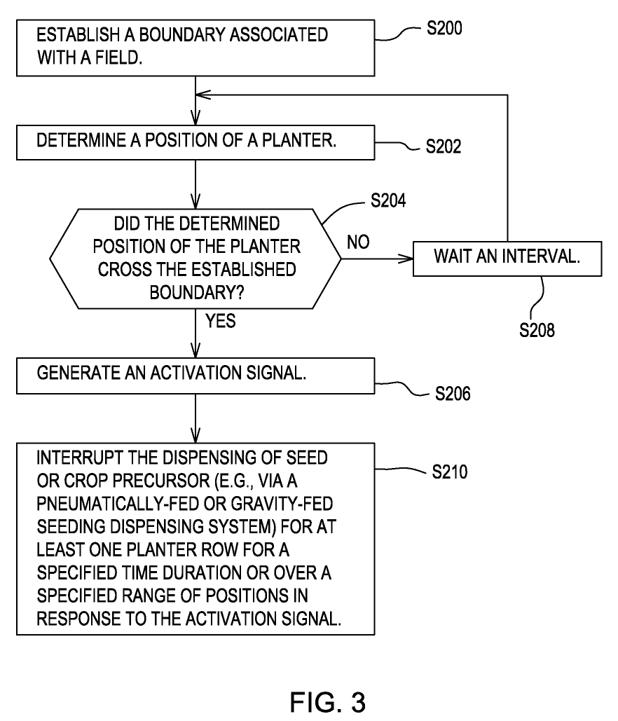

FIG. 3 illustrates a method for controlling a planter. The method of FIG. 3 begins in step S200.

In step S200, the boundary definer 22 or data processor 12 establishes a boundary associated with a field. Step S200 may be executed in accordance with various techniques that may be applied alternately or cumulatively. Under a first technique, the boundary definer 22 may establish a boundary based on a pre-existing map or survey of the field or work area.

Under a second technique, the boundary definer 22, may establish a boundary, boundary point, or boundary segment dynamically via the operator interface 16 as the operator navigates through the field during a planting operation, a pre-planting task, plowing, harrowing, a soil preparation, or another agronomic procedure. Accordingly, via the operator interface 16 the operator can manually, selectively and independently activate or deactivate the flow of seed or crop precursor to one or more outer rows of the planter that coincide with one or more corresponding boundary points to create notches in rows of the planted crop.

Under a third technique, if the planter plants or traverses a headland, the boundary definer 22 (or operator via the user interface 16) may dynamically and automatically establish a headland boundary. A headland boundary is an internal boundary, a boundary point or boundary segment associated with a headland interior edge or spaced apart by a desired clearance distance from an inner row of the headland with respect to the field. Accordingly, via the operator interface 16 the operator can manually, selectively and independently activate and deactivate the flow of seed or crop precursor to one or more outer rows of the planter that coincide with the headland boundary, even if there is no pre-existing map or survey of the field. Further, via the operator interface 16 the operator can create notches in the planted crop adjacent to the headlands created during the same planting operation.

Under a fourth technique, the boundary comprises a contour or generally linear segment spaced apart from an edge or external edge of the field.

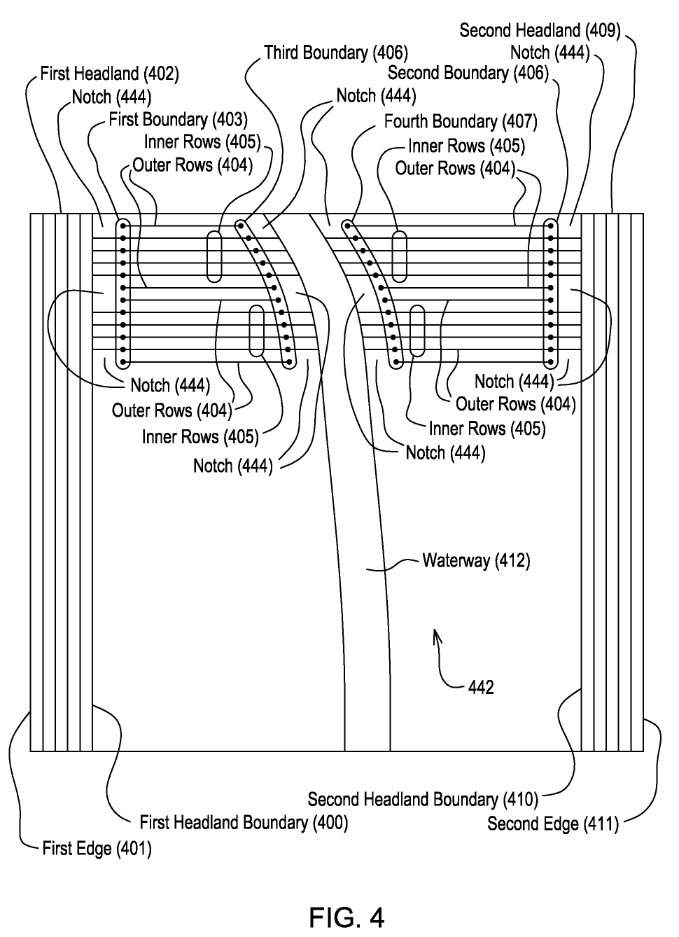

Under a fifth technique, the boundary comprises an internal boundary within the field, where the internal boundary is associated with a waterway (e.g., 412 in FIG. 4), a grassland zone, a non-traversable zone, or a traversable zone. A non-traversable zone is not traversable by the planter, or by a vehicle moving the planter. A traversable zone area is traversable by the planter, or by a vehicle moving the planter. A traversable zone or non-traversable zone may comprise a reserved area for erosion prevention, a watershed stewardship area, or a conservation area in which crop is not planted or cultivated. A waterway may be considered a traversable zone or a non-traversable zone, depending upon the depth of the water, the rate of flow of the water, and its width, among other factors, for example. If the internal boundary is associated with a non-traversable zone, the boundary definer 22 or operator may define one or more headlands that border the non-traversable zone.

Under a sixth technique, if the planter plants near or traverses a waterway or another traversable zone, the boundary definer 22 or operator via the user interface 16 may dynamically and automatically establish a traversable boundary. A traversable boundary is an internal boundary, a boundary point or boundary segment associated with a traversable zone's interior edge or spaced apart by a desired clearance distance from the interior edge with respect to the field. Accordingly, via the operator interface 16 the operator can manually, selectively and independently activate and deactivate the flow of seed or crop precursor to one or more outer rows of the planter that coincide with the traversable boundary (e.g., waterway). For instance, the operator could create a notch in the planted crop on the trailing edge of internal waterways, where the operator manually activates the planter after deactivating it during traversal of the internal waterway.

In step S202, a location-determining receiver 10 determines a position of a planter. The location-determining receiver 10 may comprise a Global Positioning System (GPS) receiver with a differential correction receiver for position correction data provided by one or more satellites or a terrestrial base station. The determined position may be expressed as location data, geographic coordinates (e.g., longitude, latitude), or otherwise. The location-determining receiver 10 is carried by the planter or mounted on the planter.

In step S204, a detector 24 or data processor 12 determines if the position of the planter crosses the established boundary. The detector 24 is capable of generating an activation signal for a specified time duration or over a specified range of position if the location-determining receiver 10 crosses the established boundary. If the planter crosses the established boundary, the method continues with step S206. However, if the planter does not cross the established boundary, the method continues with step S208.

In step S206, a controller 26 or data processor 12 generates an activation signal. The activation signal may comprise one or more of the following: an analog signal, a digital signal, a status message, a command signal, control data, or otherwise.

In step S208, the data processor 12 waits a time interval prior to returning to or executing step S202. In one embodiment, the time interval may be selected to be commensurate with one or more of the following factors: an average, mean or mode velocity of the planter or vehicle, a maximum velocity of the planter or vehicle, the size of the work area, the dimensions of the work area, the quantity of external and internal boundaries, and the average, mean or mode distance between boundaries.

In step S210, an actuator 14 interrupts (e.g., suspends or halts) the dispensing of seed (e.g., via pneumatically-fed or gravity-fed dispensing system) or a crop precursor for at least one planter row in response to the activation signal for a specified time duration or over a specified range of positions. Step S210 may be carried out in accordance with various techniques that may be applied separately and cumulatively.

In accordance with a first embodiment, the at least one planter row comprises two outer planter rows of the planter that are separated by one or more inner planter rows. A planter may have N planter rows, where N is a whole number greater or equal to one (1). For instance, a high capacity planter may have N planter rows, where N equals 36, which includes 34 inner planter rows and 2 outer planter rows.

In accordance with a second embodiment, the controller 26 or data processor 12 generates an activation signal (e.g., control data, a data message, or a control signal) for the specified time duration or over a specified range of positions. The specified time duration may be commensurate with or proportional to the speed of the planter to produce a visual marker of recognizable scale or size. The visual marker may be a notch or absence of plants in a row. The specified range of positions may be defined by reference to one or more of the following: the boundary, a pair of starting coordinates and ending coordinates, a range of coordinates or positions, and absolute coordinates or positions.

In accordance with a third embodiment, the controller 26 or data processor 12 generates an activation signal or data message that triggers the actuator 14 to remain in a non-dispensing state or interrupt the dispensing of seed or a crop precursor for the specified time duration or over a specified range of positions. In accordance with a fourth embodiment, the controller 26 or data processor 12 disrupts the dispensing of the seed or the crop precursor for the specified time duration for an outer row of the planter to produce a visually observable notch (e.g., of minimum length) or absence of crop plants (e.g., for minimum length) in a planted row of crop. In accordance with a fifth embodiment, the controller 26 or data processor 12 disrupts the dispensing of the seed or the crop precursor over the specified range of positions for an outer row of the planter to produce a visually observable notch (e.g., of minimum length) or absence of crop plants (e.g., for a minimum length) in a planted row of crop. In accordance with a sixth embodiment, the controller 26 or data processor 12 interrupts the dispensing of seed or the crop precursor for the specified time duration or over the specified range to produce a visually observable notch (e.g., of minimum length) in the planted rows of crop when the dispensed seed matures.

In accordance with a seventh embodiment, the user interface 16 allows an operator of the planter to select outer rows 404, the specified time duration and the specified range positions. The specified range of positions may include a first position of the planter associated with the activation of an actuator 14 and a second position associated with the deactivation of the actuator 14. Both the first position and the second position may be associated with a corresponding boundary point, boundary coordinates or boundary. The first position, the second position, the specified time duration and the specified range of positions may be stored in the data storage device 20 for subsequent reference.

FIG. 4 illustrates an aerial view of a field that is planted in accordance with the method of FIG. 3 or via the system of FIG. 1 or FIG. 2. Although the field is illustrated as a generally rectangular area, the field may have virtually any geometric or other shape. Here, the field is divided into two sections by a stream, irrigation canal or drainage ditch, or other waterway 412.

In one embodiment illustrated in FIG. 4, each pass of the planter may cover one or more inner rows 405 bounded by two outer rows 404. At the start of a pass or path of the planter near a boundary (403, 406, 407 or 408) associated with an edge (401, 411) of the field, a notch 444 may be placed in one or more outer rows 404. Similarly, at the end of a pass or path of the planter near a boundary (403, 406, 407, 408) associated with an edge (401, 411) of the field, a notch 444 may be placed in one or more outer rows 404. In addition, the planter may place a notch 444 in the outer rows 404 that are nearest or adjacent to a boundary (406, 407) of the waterway 412.

In one embodiment, the notches 444 in the rows may be used as visual reference markers by an operator of a sprayer, a harvester, a combine or another agricultural machine to facilitate an agricultural task (e.g., harvesting, spraying and treating crops). For example, the operator may use the notches in the rows to determine which rows have been covered or traversed (e.g., by a sprayer), and which rows need to be covered or traversed.

In FIG. 4, the field has a first headland 402 and a second headland 409 at each end, where multiple headland rows are generally perpendicular to intermediate rows in an intermediate section 442 of the field between the headlands. The intermediate section 442 is separated from the first headland 402 by a first headland boundary 400. The intermediate section 442 is separated from the second headland 409 by a second headland boundary 410.

A first boundary 403 is spaced apart from a first edge 401 of the field, a first headland 402, and a first headland boundary 400. A second boundary 408 is spaced apart from a second edge 411 of the field, a second headland 409, and a second headland boundary 410. A third boundary 406 and a fourth boundary 407 are spaced apart from a waterway 412 that runs through or divides the intermediate section 442 of the field. Each of the foregoing boundaries is indicated by dotted lines as shown in FIG. 4. The first boundary 403, the second boundary 408, the third boundary 406, and the fourth boundary 407 are the boundaries that trigger the formation of the notches 444 in the outer rows 404. For instance, any of the foregoing boundaries (403, 406, 407 and 408) may be stored as boundary data 28 in the data storage device 20 that is established pursuant to step S200 of FIG. 3.

Having described the preferred embodiment, it will become apparent that various modifications can be made without departing from the scope of the invention as defined in the accompanying claims.

The following is claimed:

1. A system for controlling a planter, the system comprising:
a boundary definer for establishing a boundary associated with a field;
a location-determining receiver for determining a position of a planter;
a detector for generating an activation signal if the determined position of the location-determining receiver crosses the established boundary; and
an actuator for interrupting the dispensing of seed or another crop precursor for a planter row for a specified time duration or over a specified range of positions in response to the activation signal.

2. The system according to claim 1 wherein the planter row comprises at least one outer row of the planter.

3. The system according to claim 1 wherein the actuator disrupts the dispensing of the seed or the crop precursor for the specified time duration for an outer row of the planter to produce a visually observable notch or absence of crop plants in a planted row of crop.

4. The system according to claim 1 wherein the actuator disrupts the dispensing of the seed or the crop precursor over the specified range of positions for an outer row of the planter to produce a visually observable notch or absence of crop plants in a planted row of crop.

5. The system according to claim 1, wherein the actuator interrupts the dispensing of seed or the crop precursor for the specified time duration or over the specified range to produce a visually observable notch in the planted rows of crop when the dispensed seed matures.

6. The system according to claim 1 further comprising:
a user interface for allowing an operator of the planter to select at least one of a number of outer rows, the specified time duration and the specified range.

7. The system according to claim 1 wherein the boundary comprises a contour or linear segment spaced apart from an edge or external edge of the field.

8. The system according to claim 1 wherein the boundary comprises an internal boundary within the field, the internal boundary associated with a waterway, a grassland zone, a traversable zone, or a non-traversable zone that is not traversable by the planter.

9. The system according to claim 1 further comprising a data storage device for storing a position of the planter associated with the activation of the actuator, the deactivation of the actuator, or both.

10. The system according to claim 1 wherein the actuator further comprises:
a supply container for storing the seed or the crop precursor;
a dispensing valve having an inlet and an outlet, the inlet in communication with the supply container elevated above the dispensing valve; and
the actuator arranged for opening the dispensing valve to provide an open state to facilitate movement of the seed or the crop precursor, at least partially by gravity, from the inlet to the outlet.

11. The system according to claim 1 further comprising:
a seed supply container for storing the seed or the crop precursor;
a dispensing valve having an inlet and an outlet, the inlet in pneumatic communication with the supply container; and
the actuator arranged for opening the dispensing valve to provide an open state to facilitate movement of the seed or the precursor, at least partially by an air or gaseous pressure differential, between the inlet to the outlet.

12. A method for controlling a planter, the method comprising:
establishing a boundary associated with a field;
determining a position of a planter via a location-determining receiver;
generating an activation signal if the determined position of the planter crosses the established boundary; and
interrupting the dispensing of seed or another crop precursor for a planter row for a specified time duration or over a specified range of positions in response to the activation signal.

13. The method according to claim 12 wherein the planter row comprises at least one outer row of the planter.

14. The method according to claim 12 wherein the interrupting further comprises disrupting the dispensing of the seed or the crop precursor for the specified time duration for an outer row of the planter to produce a visually observable notch or absence of crop plants in a planted row of crop.

15. The method according to claim 12 wherein the interrupting further comprises disrupting the dispensing of the seed or the crop precursor over the specified range of positions for an outer row of the planter to produce a visually observable notch or absence of crop plants in a planted row of crop.

16. The method according to claim 12 wherein the interrupting further comprises interrupting the dispensing of seed or the crop precursor for the specified time duration or over the specified range to produce a visually observable notch in the planted rows of crop when the dispensed seed matures.

17. The method according to claim 12 further comprising:
allowing an operator of the planter to select at least one of a number of outer rows, the specified time duration and the specified range.

18. The method according to claim 12 wherein the boundary comprises a contour or linear segment spaced apart from an edge or external edge of the field.

19. The method according to claim 12 wherein the boundary comprises an internal boundary within the field, the internal boundary associated with a waterway, a grassland zone, a traversable zone, or a non-traversable zone that is not traversable by the planter.

20. The method according to claim 12 further comprising:
storing a position of the planter associated with the activation of an actuator, the deactivation of the actuator, or both.
